(19) United States
(12) Patent Application Publication
(10) Pub. No.: US 2014/0113663 A1
(43) Pub. Date: Apr. 24, 2014

(54) COMMUNICATIONS METHOD, DEVICE AND SYSTEM

(71) Applicant: Zhigang Ma, Northville, MI (US)

(72) Inventor: Zhigang Ma, Northville, MI (US)

(21) Appl. No.: 13/655,644

(22) Filed: Oct. 19, 2012

(51) Int. Cl. H04W 8/18; H04W 24/00

(52) U.S. Cl. 455/457

(57) ABSTRACT

A communications device receives a broadcast wireless communication transmission from a sender to initiate communication with the device. The received transmission includes the sender's identification, location information and other information about the transmission. The device maps relative locations of the sender and the device on a display of the device. The device also looks up a profile about the sender at a remote resource and updates the information about the sender. The device responds to the received transmissions by a broadcasting wireless communication transmission under certain situations. The remote resource may inform the sender of the profile lookup by the sender and provides the sender with the device's identification and location information.

### CROSS-REFERENCE TO RELATED APPLICATIONS

None.

### BACKGROUND OF THE INVENTION

1. Field of the Invention

This invention generally relates to communications devices and, particularly, to a short-range broadcasting communications device and methods used by such a communications device to communicate with other devices.

2. Description of Related Art

Nowadays, for users of the mobile communications devices, a pre-condition for them to communicate with each other is that the one who initiates the communication must know the other's phone number, email address, or some other kinds of communication identifiers (IDs) in order to establish such communications, either via telephonic calls, the Internet communications, or video calls. However, more often than not, people desire to meet strangers or those of interest to them in some public occasions, for instance, in a hotel lobby, a coffee shop, or even on the street, but if the one who would like to initiate the contact does not know the other's phone number or email address, the only way to approach the other one is to come up to start a direct talk. In some situations, a direct talk may seem intruding, or socially inappropriate.

For business owners, specifically targeting potential customers within proximity of their business may generate immediate sales. More importantly, using a short-range broadcasting communication to advertise business can save cost otherwise needed in doing conventional advertisement, such as cost in paper printing, designing, etc., and provide an environment-friendly way for promoting their products.

The invention presented in this disclosure is to provide an innovative approach in people-to-people communications within short distances by using their communications devices, to create a new type of communications system employing the devices.

### BRIEF SUMMARY OF THE INVENTION

In view of the foregoing and other issues, drawbacks, and disadvantages of the conventional methods and devices of communications, an exemplary feature of the present invention is to provide easy and convenient methods and devices for establishing contact among people who don't know each other, and are within short distances. The invention disclosed through exemplary embodiments here tries to provide an innovative solution for short-range communications among peoples, especially for those who don't know each other before the communications. The solution provides communication methods and devices employed the people. A device used by a person who initiates the communication sends out short-range broadcasting signals that includes a special sender identifier (sender ID) for the communication transmission, the location information of the person, contact information, and other information as desired; a device held by another person that receives the broadcast signals then retrieves the sender ID, the location information of the sender, i.e., the device that sent out the request, and the contact information and other information embedded within the transmission. The receiving device maps the location of the sending device based on the location information, and the location of the receiving device, and displaying the information regarding the transmission. The profile of the sending device, or the sender, may be looked up either locally within the receiving device, or remotely at a networked remote resource. The person using the receiving device can see the location of the sending device on the map, and the purpose of the transmission from the map, and when the person using the receiving device decides to respond to the transmission, he or she can use the contact information from the sender to contact the person using the sending device, either by sending a response via a short-range broadcasting signal to the sender, or via other communication means.

Additionally, when the receiving device looks up the profile of the sender ID remotely with the remote resource, it may also provides its own location information and contact information. The remote resource may then contact the sending device to inform the lookup of the request by the receiving device and provide location information and other information of the receiving device. Invitation to register with remote resource may also be solicited.

### BRIEF DESCRIPTION OF THE SEVERAL VIEWS OF THE DRAWING(S)

The foregoing and other exemplary purposes, aspects and advantages of the present invention will be better understood in principle from the following detailed description of one or more exemplary embodiments of the invention with reference to the drawings, in which:

FIG. 1, a schematic view, illustrates an exemplary embodiment of a communications device displaying a map showing received communication transmissions, and a communication environment;

FIG. 2, a functional block diagram, illustrates components of the communications device of FIG. 1, in accordance with an embodiment;

FIG. 3, a flowchart, illustrates a flow of processing of a communication transmission received by the communications device of FIG. 1, in accordance with an embodiment;

FIG. 4 further illustrates a detailed flow of an exemplary embodiment of profile lookup of FIG. 3;

FIG. 5 further illustrates details of an exemplary embodiment of map-rendering of FIG. 3;

FIG. 6 further illustrates details of an exemplary embodiment of responding to the communication request of FIG. 3;

FIG. 7 further illustrates an exemplary embodiment of filtering the received communication transmission of FIG. 3;

FIG. 8, a schematic, block diagram, illustrates contents for a request or a response communication transmission;

FIG. 9, is a flowchart illustrating a remote resource communicating with a sender of the received communication transmission; and

FIG. 10, a schematic diagram, showing a communications system including the communications device, the sender and the remote resource, especially the way the remote resource communicating with the sender.

### DETAILED DESCRIPTION OF THE INVENTION

The invention will now be described in detail through several embodiments with reference to the accompanying drawings.

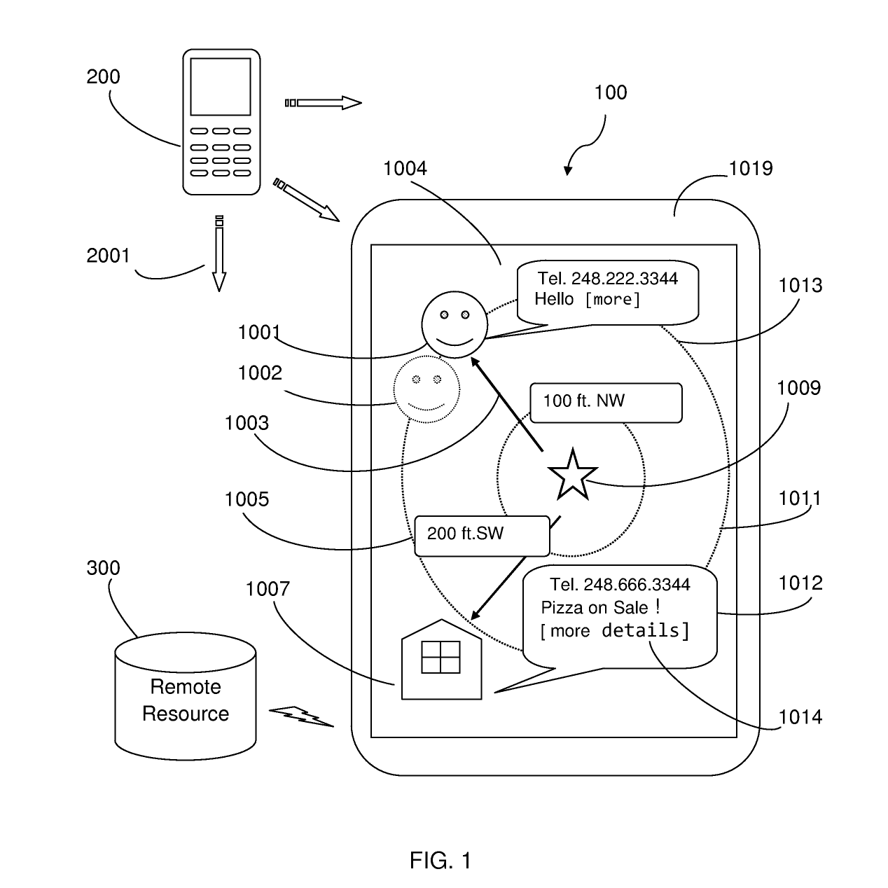

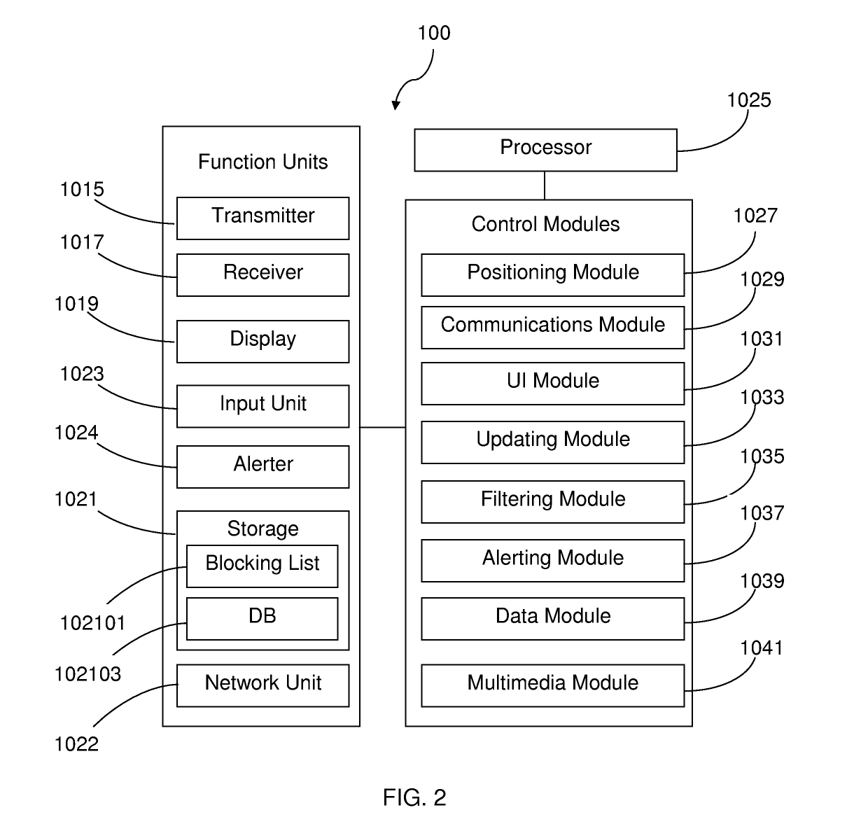

Referring now to the drawings, and more particularly to FIGS. 1-2, an exemplary embodiment of a communications device 100 is illustrated. The device 100 has several function units that include a transmitter 1015, a receiver 1017, a display 1019, a storage unit 1021, a network unit 1022, an input unit 1023, and an alerter 1024. The communications device (“device”) 100 has at least one processor 1025, which executes and controls various control modules that include a positioning module 1027, a communications module 1029, an interface (UI) module 1031, an updating module 1033, a filtering module 1035, an alerting module 1037, a data module 1039, and a multimedia module 1041. Each of the control modules can be implemented either as hardware with firmware embedded therein or as software module, as far as technologies and other considerations are concerned.

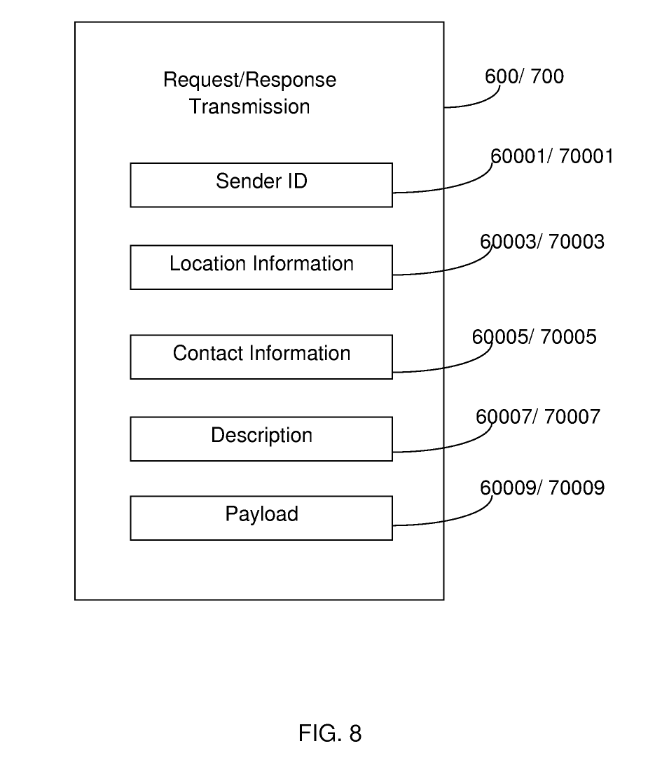

The positioning module 1027 and the communications module 1029 control the transmitter 1015 and the receiver 1017 to communicate with other devices, such as mobile devices, fixed communications devices, positioning satellites, or indoor positioning systems. The receiver 1017 receives communication transmission (“transmission”) from a sender device (“sender”) 200, being either a request to communicate (“request transmission”) with the user of the device 100, or a response to a communication request (“response transmission”) from the device 100. The transmitter 1015 sends transmission to other devices. Taking a transmission from the sender 200 (“received transmission”) as example, the communication signals carrying received transmission may be a short-range wireless communication signals, such as BLUETOOTH signals, WIFI signals, near field communication (NFC) signals, radio signals within FRS/GMRS or UHF ranges, or any other radio frequency signals suitable for short-range communications. The communication signals may be signals for connection inquiries, like in BLUETOOTH, in FRS/GMRS radio frequencies, or other pre-determined communication signals, and are broadcast blindly towards surrounding area where the device 100 is in. In one embodiment, the contents of the received transmission will be able to be processed by the device 100 without going though security routines, pairing/acceptance checks. Such a received transmission may have a structure like a transmission 600 shown in FIG. 8 (Labels “700” series indicates an out-going transmission from the device 100). The received transmission 600 includes a sender ID segment 60001, which can be pre-set by the sender 200, or set by the user of the sender 200; a location information segment 60003, which indicates the location of the sender of the received transmission 600; a contact information segment 60005 about the sender, which may include a phone number, a specific ID for an account with a specific networked resource, or any other recognizable contact information by the device 100. The received transmission 600 may further includes a description segment 60007 for describing the purpose of the communication, e.g., what the purpose of the transmission is, or whether this transmission is a response transmission, etc. Alternatively, the format of the sender ID 60001 may be specific enough to indicate whether the transmission 600 is a request transmission or a response transmission, following a pre-determined syntax. For instance, the sender ID 60001 may be as simple as a single section ID “XXXXX” to represents the sender 200, or a composite, multiple section ID as in syntax like “AAA-BBB-CCC-DDD,” where the “AAA” represents the sender, the “BBB” represents the type of the transmission, i.e., a request or a response, the “CCC” represents an ID of a previous communication the transmission is responding to, and the “DDD” may represents an alternative ID registered with a third party resource where more information about the sender is available. A payload segment 60009 may also be included in the received transmission 600 to include multimedia contents for the device 100 to process and execute. The format of the structure of the transmission 600, including those of the segments can be pre-determined, following certain syntaxes, e.g., in name-value pairs, or in layered structures.

The receiver 1017, controlled by the positioning module 1027, receives location information of the device 100, such as positioning data from satellites, e.g., from the GPS system, or from an indoor positioning system (IPS). When both satellite signals and IPS signals are strong and equal to or above pre-defined threshold values, a priority may be given to one kind of signals over the other, e.g., using IPS data as location information, instead of, e.g., GPS data, or vise versa. On the other hand, when one kind of positioning data, e.g., GPS signals, is weak and lower then the pre-defined threshold values, the other kind of positioning data, e.g., IPS data, will be used as location information. If the device 100 is fixed in a location, then the location information may be entered via the input unit 1023 by the user of the device 100, in such case, the positioning module will not use the positioning data received by the receiver 1017, and the user input positioning data will be used as the location information.

The communications module 1029 controls the receiver 1017 to receive transmissions from the sender 200, which could be request transmissions or response transmissions. The transmissions may have the same or similar structures as the one shown in FIG. 8. After receiving the transmission 600, the data module 1039 first recognizes the data structure of the received transmission 600 and then retrieves data form therefrom. The data module 1039 gets the sender ID 60001, location information 60003 of the sender 200, the contact information 60005, description 60007 of the received transmission 600, and the payload 60009 if there is one.

After the data module 1039 has retrieved necessary data about the received transmission 600, the filtering module 1035 starts filtering the received transmission 600. The filtering module 1035 checks the retrieved data to determine whether the transmission 600 is a request transmission or a response transmission based on the retrieved data, and marks the received transmission 600 accordingly. The filtering module 1035 further determines whether the sender ID 60001 is in a blocking list 102101 maintained by the device 100 in its storage 1021, or whether the type of the retrieved transmission 600 based on the retrieved description 60007, a timestamp of receipt of the transmission 600, or the distance of the sender based on the retrieved location information 60003 should also blocked by the criteria of the blocking list 102101. When the filtering module 1035 determines that the received transmission 600 should be blocked according to the blocking list 102101, the retrieved transmission 600 will not be processed further by the device 100, except that the updating module 1033 will update a database (DB) 102103 maintained in the storage 1021 to log the transaction.

When the received transmission 600 passes through the filtering process by the filtering module 1035, several processes ensue. The alerting module 1037 may alter the user of the device 100 on the received transmission 600, either by audio, visual or mechanical means via the alerter 1024; the interface (UI) module 1031 will render a visual layout of the communication situations on the display 1019 of the device 100; the data module 1039 may further look up the sender's profile either locally or remotely based on the sender ID 60001 and other information from the retrieved data. In connecting to a networked remote resource 300, such as an online application, to do a profile lookup remotely, the communications module 1029 will control the network unit 1022 to establish network connections with the remote resource 300.

In rendering the visual layout of communication situations by the UI module 1031, various formats of layout can be employed, such as using a simple listing style, or a more complex, picturesque layout. The rendering process is hereby called mapping, and the result would be a map 1004 of the communication situation. Referring to FIG. 1, an exemplary embodiment of mapping is shown, as rendered on the display 1019. The UI module 1031 draws an symbol 1009 to indicate the location of the device 100 according to the location information provided by the positioning module 1027, and a symbol 1001 to indicate the current position of the sender of the transmission 600 based on the retrieved location information 60003. Other symbols to represent other locations of communication transmissions, such as the one 1007 from a business, are also be displayed. Symbols 1003 and 1007 can also be drawn to indicate the distances and relative directions between the senders of the transmissions and the symbol 1009 of the device 100. For instance, symbol 1003, an arrow line, is drawn to give a visual feeling of the distance between sender symbol 1001 and the symbol 1009 of the device 100; symbol 1005 displays relative directions of the business 1007 to the symbol 1009, and the distance in feet. Message box 1012 may also be drawn by UI module 1031 to display more information based on retrieved contact information 60005 and description 60007. Additionally, reference lines 1013 can be drawn in the background of the display 1019 to give the user of the device 100 a quick estimation of distances between senders of communication transmissions and the device 100, concentric circles 1013 are used here as example on the display 1019.

In case the sender 200 is on the move while sequentially or intermittently sending multiple transmissions 600, in other words, the transmissions 600 are received in time sequence, as long as the transmissions 600 received has the same sender ID or similar IDs 60001 which can be recognized as the same sender by the device 100, specifically, for instance, by the data module 1039 or the communications module 1029, multiple symbols 1001, 1002, etc. may be drawn on the display 1019 to show the movement of the sender 200. In one embodiment, symbol 1002 is drawn in dashed lines to indicate a previous location based on previous location information retrieved by the data module 1039 from a previously received transmission, and the symbol 1001, in solid lines, is for the current location.

The user of the device 100 then may select a sender displayed in the display 1019 and check out associated information such as those in the message box 1012, and go deeper down for more information by selecting “more details” symbol 1014. In case there is a multimedia payload 60009, such as text, visual or audio contents, the user may select to check out the payload 60009, and the multimedia module 1041 will execute the payload 60009. The user can also check if the received transmission 600 is a response transmission responding to an out-gone request transmission from the device 100, as such a response is marked differently by the data module 1039, and displayed accordingly, either on the symbol 1001, or in the associated message box 1014.

If a profile associated with the sender ID 60001 can be found by the data module 1039, either locally or remotely, the updating module 1033 may update the map 1004, based on the profile found. For instance, the message box 1014 for the sender 200 can be updated by adding more information about the sender, including personal profile, additional contact information via other means, such as a user identifier registered with the remote resource 300, etc.

If the user of the device 100 decides to respond to the received transmission 600 from the sender 200 which interests him or her, the user can then use the retrieved contact information 69995 of the sender 200, as updated, if any, to contact the sender by letting the data module 1039 to prepare contents for an out-going transmission 700 as depicted by FIG. 8, in which the location information 70003 will be gathered by the positioning module 1027 via the receiver 1017, and the out-going transmission 700 will be marked as a response transmission by the data module 1039 either in the description segment 70007 or by the sender ID 70001 as agreed upon by the pre-determined syntaxes between the sender 200 and the device 100. In one embodiment, the contents of response can be set in the description segment 70007 as, for instance, textual message, and any multimedia contents can be set in the payload segment 70009, therefore, the response will not be a real-time, instant communication as a telephone call. The prepared out-going transmission 700 will be transmitted as broadcasting signals by communications module 1029 via the transmitter 1015 to the sender 200. Alternatively, the device 100 may first get paired with the sender 200 if sufficient information for paring was got from the received transmission 600, like pairing in BLUETOOTH communications, and then send the out-going transmission 700 via the transmitter 1015 specifically targeting the sender 200 without broadcasting the response. After responding, the symbol 1001 may be changed, for instance, in color, or shape, etc., indicated as an already responded sender. The updating module 1033 may update the message box 1014 associated with the symbol 1001 to reflect the contents in the response.

If the retrieved contract information 60005 from the received transmission 600 contains a telephone number, the user of the device 100 may directly phone the text the sender via the phone number. If other communication means are provided either in the retrieved contact information 60005, or from the profile found, for instance, a user ID with the remote resource 300, the user of the device 100 may contact the sender via the remote resource 300.

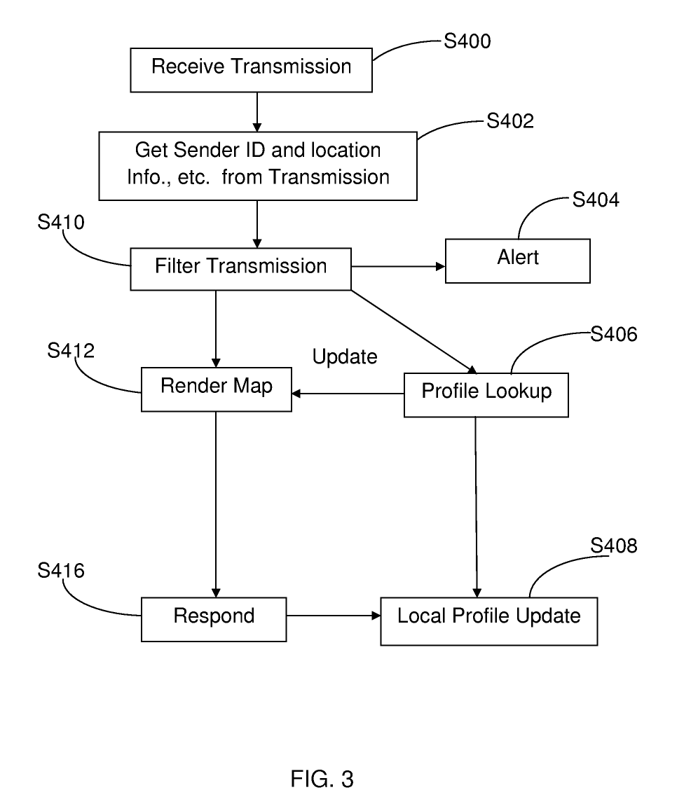

FIG. 3 shows an exemplary flowchart for a method of processing the transmission 600 received by the device 100. The figure shows only exemplary steps in an embodiment to describe the principles of the method, and the order of the steps is not necessarily fixed as shown, might be altered, and certain steps might be omitted without departing from the principles of the invention.

In step S400, the receiver 1017 receives the transmission 600 broadcast from the sender 200. In step S402, the contents of the transmission are processed by the data module 1039, and the sender ID 60001, the location information 60003, the contact information 60005, and other segments as depicted in FIG. 8 are respectively retrieved.

After the data retrieval, the received transmission 600 will be filtered by the filtering module 1035 in step S410. If the filtering module determines that the transmission 600 should not be clocked based on the blocking list 102101, then the process goes on, either synchronously or asynchronously, to steps S404, S406 and S412. In step S404, the alerting module 1037 will control the alerter 1024 to alert the user of the device 100 of the received transmission 600. In step S412, the UI module 1032 will render the map 1004 on the display 1019. And in step S406, the data module 1039 will look up the sender ID 60001 either locally through the DB102103 or remotely through the remote resource 300. Alternatively, if the received transmission 600 meets certain criteria set by the blocking list 102101, the filtering module 1035 may respond to the transmission 600 by using a pre-set response. For instance, if the retrieved sender ID is a pre-determined one, or if the retrieved description 60007 contains certain keywords, or contents, the filtering module 1035 will ask the data module 1039 to load the pre-determined response, and the communications module 1029 will control the transmitter 1015 to send a response transmission 700 as depicted in FIG. 8 to the sender 200.

After the lookup, if a profile associated with the sender ID 60001 is found, the updating module 1033 will update the map 1004 in step S412 with the profile, and meanwhile, update the DB 102103 with the profile either through updating profile data in the DB 102103 with the received transmission 600, or creating a new profile of the sender ID 6001 with the received transmission if no profile matching the sender ID 60001 already exists in the DB 102103.

After the map 1004 has been rendered in step S412, or after the map 1004 has been updated by the updating module 1033 with the found profile, the user of the device 100, after viewing the information displayed on the map 1004, may, in step S416, decide to respond to the received transmission 600. In doing so, the data module 1039 will prepare a response transmission 700 and the communications module 1029 will control the transmitter 1015 to either send the response transmission 700 to the sender 200, or to use the retrieved contact information 60005 from the sender 200 to contact the sender 200, or the sender via other means. If the received transmission 600 contains a payload 60009 of multimedia contents, the device 100 may choose to playback the multimedia contents either automatically by pre-set rule or by the user of the device 100.

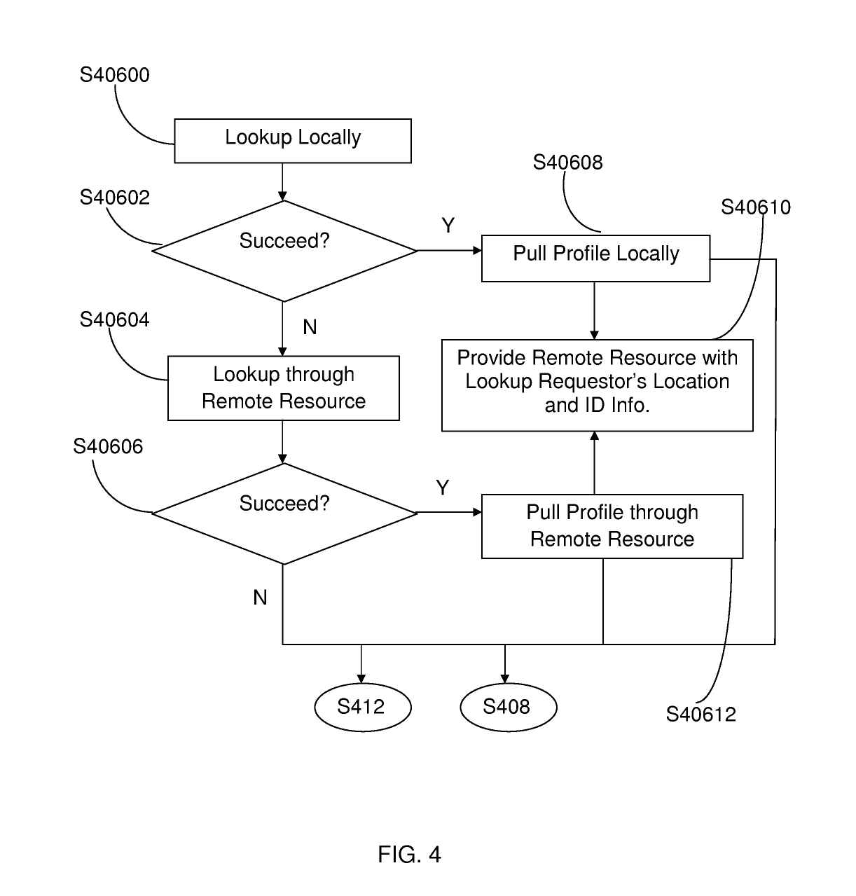

Various steps in FIG. 3 can have further detailed implementations. FIGS. 4-7 show flowcharts illustrating exemplary embodiments of some steps in the method of FIG. 3. Again, each of those figures shows only exemplary steps in an embodiment to describe the principles of the method, and the order of the steps is not necessarily fixed as shown, might be altered, and certain steps might be omitted without departing from the principles of the invention.

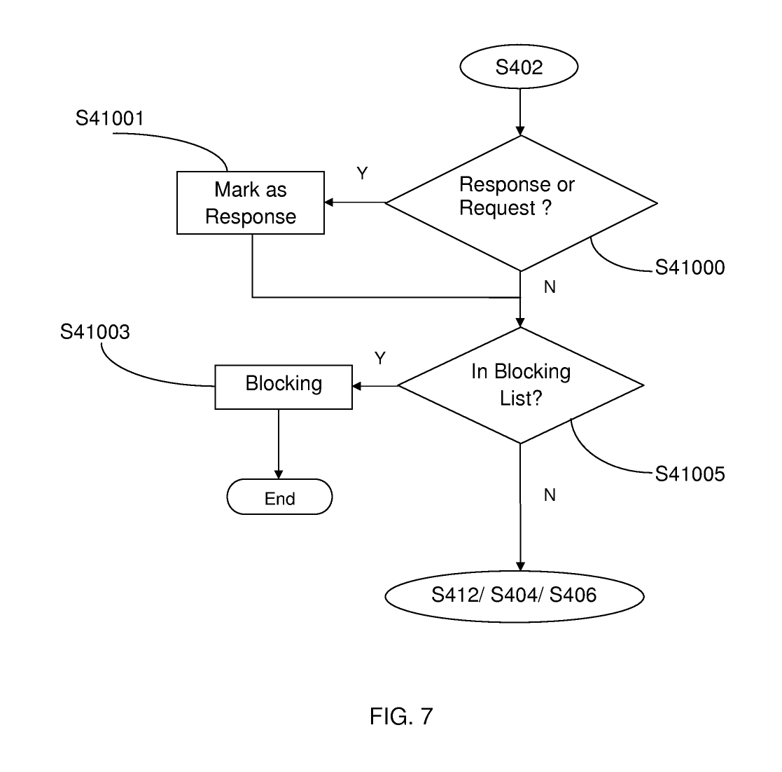

FIG. 7 illustrates an exemplary embodiment of step S410 of filtering the received transmission 600 in FIG. 3. In step S41000, the filtering module 1035 detects whether the received transmission 600 is a request transmission or a response transmission, by either examining the retrieved description segment 60007, or alternatively by directly examining the sender ID which might includes specific indicator. If the received transmission 600 is a response transmission to an out-gone transmission 700 from the device 100, the received transmission 600 will be marked specially as a response transmission. The filtering module 1035 will continue to check whether the retrieved sender ID 60001 is in the blocking list 102101 or not, if a match is found, then in step S41003, the receiver transmission 600 will be blocked; otherwise, the process will proceed to the steps S412, S404 and S406, as shown in FIG. 3.

An embodiment of profile lookup in step S406 is illustrated in FIG. 4. In step S40600, the data module 1039 will first query the DB 102103 to try to retrieve a profile associated with the retrieved sender ID 60001, if such a profile exists in step S40602, the DB 102103 will return the profile in step S40608 and the updating module 1033 will use the profile to update the map 1004 in step S412, and may also update the profile in the DB 102103 about the received transmission 600. If the sender ID 60001 or the retrieved contact information 60005 includes a user identifier with the remote resource 300, the data module 1039 may, in step S40610, inform the remote resource 300 of the lookup by the device 100 by providing the retrieved contents of the received transmission 600 and the device 100's ID and location formation, etc. Even if the retrieved contact information does not include a user identifier with the remote resource 300, the data module 1039 can still inform the remote resource 300 of the lookup with the same information.

If a profile associated with the retrieved sender ID 60001 does not exists in the DB 102103, in step S40604, the data module will connect to the remote resource 300 and query about the sender ID 60001, or any user identifier from the retrieved contact information 60005, if a profile associated with the sender ID 60001 or the user identifier is found in step S40606, the profile will be returned in step S40612, and the updating module 1039 will do the same as described in the preceding paragraph in updating the remote resource 300, and updating the map 1004 in step S412. Additionally, the updating module 1033 will create a profile for the retrieved sender ID 60001 in the DB 102103 on the received transmission 600 in step S408. In another embodiment, even if a local profile associated with the sender ID is found, the data module 1039 can still further look up for a profile at the remote resource 300 to get updated information about the sender 200.

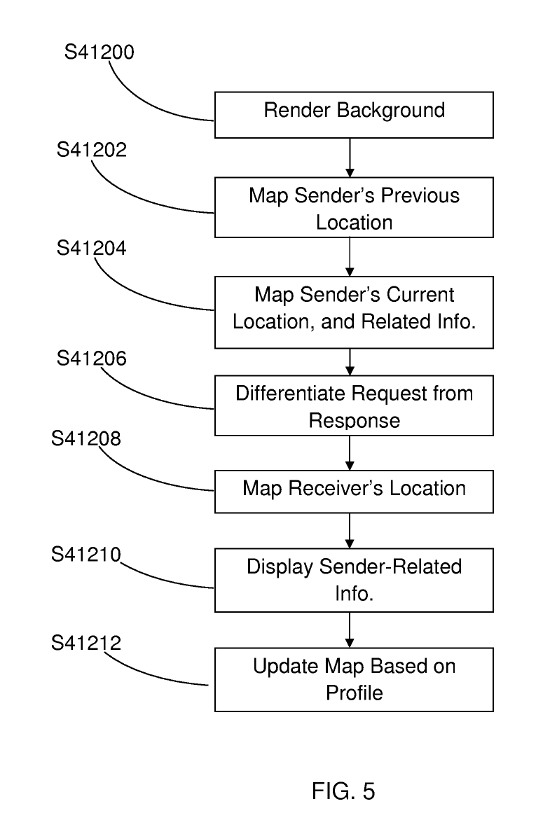

Exemplary steps of mapping are illustrated in FIG. 5, for implementing S412 of FIG. 3 in step S41200, the UI module 1031 renders background of the map 1004 on the display 1019, including drawing the reference lines 1013, and any other symbols as pre-defined by the user of the device 100. In step S41202, the UI module 1031 draws a symbol or symbols 1002 for the previous locations of the sender 200 according to the previously retrieved location information of the sender 200 of previously received transmissions, if such transmissions existed and the location information has been retained by the device 100. In step S41204, the UI module draws the symbol 1001 for the sender's location on the display 1019 according to the retrieved location information 60003 currently being received. In step S41206, if the received transmission 600 has been marked by the data module 1039 as a response transmission, the symbol 1001 will be drawn differently from the one for a request transmission, in order to differentiate the response transmission from the request transmission, by, for instance, colors, shapes, etc. In step S41208, the location of the device 100 will be drawn based on the device 100's location information from the positioning module 1027. In addition, symbols such as an arrow line 1003, and a message box 1007, can also be drawn to indicate the relative positions of the sender 200 and the device 100, and related information.

In step S41210, the UI module 1039 renders some sender-related information on the map 1004, such as the message box 1014, showing the retrieved contact information 60005, and the retrieved description 60007. After the lookup for the sender ID 60001 in Step S406, the map 1004 can be updated, in step 41212, based on the found profile associated with the sender ID 60001.

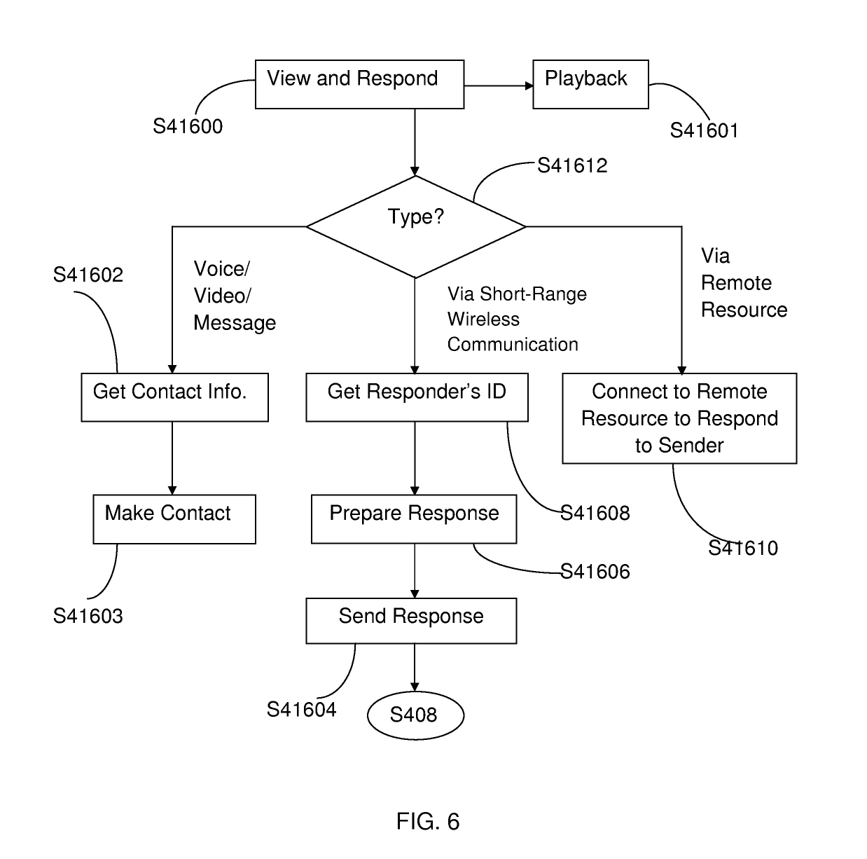

FIG. 6 shows a flowchart of exemplary steps for the device 100 to respond to the received transmission 600 in step S416. In step S41600, the user of device 100 reviews the displayed information regarding the received transmission 600 on the display 1019. If there is a multimedia content in the payload 60009, the device 100 can playback the multimedia content in step S41601. In case the sender 200 is of interest to the user of the device 100, the user may choose to respond to the received transmission 600, and select a type of response in step S41612. In step S41612, the user can select to respond via voice/video calls, or text message using the retrieved contact information 6005, or via the remote resource 300 if a user identifier with the remote resource 300 is provided by the contact information 60005. Thirdly, the user may select to respond via the same communications means as the received transmission 600.

If the user selects to respond via voice/video calls or text message, in steps S41602 and S41203, the device 100 gets the retrieved contact information 60005 and makes the calls or sends text messages. And if the user of the device 100 decides to contact the sender via the remote resource 300, in step S41610, the data module 1039 will get the sender ID 60001 or the user identifier from the retrieved contact information 60005 and connects to the remote resource to respond to the sender 200.

If, however, the user of the device 100 decides to respond via the same communications way as the received transmission 600, the process goes to step S41612 to get the device 100's ID (or the user of the device 100's ID) to set as the sender ID 70001 of an out-going response transmission 700. In step S41606, the data module 1039 will prepare the response transmission 700 in a format depicted in FIG. 8, setting various segments 70001-70009, especially the description 70007 to indicate that this is a response to the received transmission 600 associated with retrieved sender ID 60001, or includes special indicator as pre-agreed upon in the sender ID 70001 (the user/device 100's ID) to indicate the same. In step S41604, the communications module 1029 will control the transmitter 1015 to send to out-going response transmission 700 as wireless communications signals broadcast to surrounding environment including the sender 200, or after first pairing with the sender 200, then send out the response transmission specifically targeting the sender 200.

At the end of process of FIG. 6, e.g., after the step S41604, the process may invoke step S408 to update the local profile associated with the retrieved sender ID 60001 with the response transmission 700.

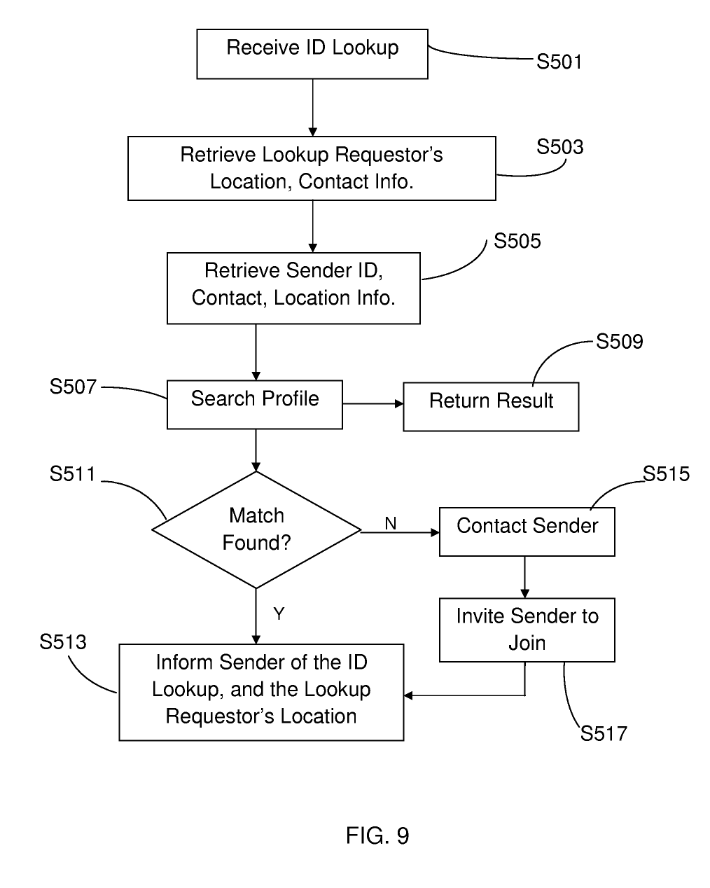

FIG. 9 illustrates possible steps at the remote resource 300 during step S406 of lookup in FIG. 3, in accordance with an exemplary embodiment. In step S501, the remote resource 300 received the request for a profile lookup from the device 100. Next, the remote resource 300 will retrieve lookup requester's ID (the device 100's ID), the requester's location information, and contact information from the lookup request. In step S505, the remote resource will further retrieve the profile ID to look up for, which could be the retrieved sender ID 60001 or a user identifier registered with the remote resource 300 and contained in the retrieved contact information 60005. The sender's location information and contact information can also be retrieved in the same step. In step S507, the remote resource searches for a profile associated with the profile ID, and the search result is then returned to the lookup requestor, i.e., the device 100 in this case, in step S509, whether or not a profile is found or not. From there, the remote resource 300 may take further steps to contact the sender 200.

If the remote resource does not find a profile matching the profile ID as requested, in step 515, it may use the contact information retrieved from the lookup request to contact and sender 200, and ask the sender 200 to register with the remote resource 300 in step S517. And whether a profile about the profile ID is found or not, the remote resource can contact the sender 200 and inform it of the lookup request by the requestor, i.e., the device 100, in step S513, by providing the device 100's location information, and contact information for the device 100.

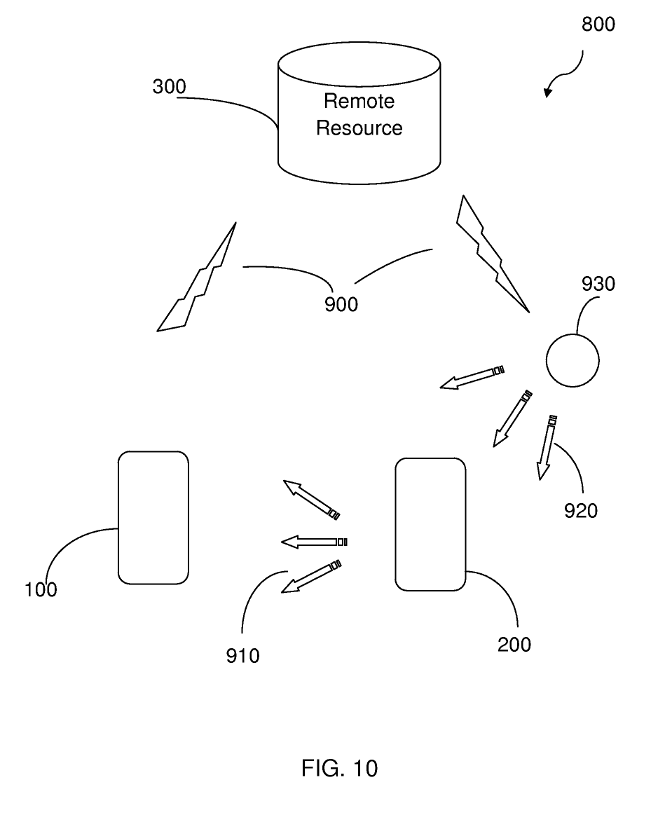

FIG. 10 illustrates a communications system 800 and networked relations among the device 100, the sender 200 and the remote resource 300. A network 900, for instance, the Internet, connects the device 100 and the remote resource 300 such that they can communicate with each other for lookup in step S406 in FIG. 3. In case the remote resource 300 decides to communicate with the sender 200, as in steps S515, S517 and S513 of FIG. 9, it can use the retrieved contact information to contact the sender either via the network 900, or other communications means, be it messaging, email, or specially-tailored format of communications, as the contact information permits. In one embodiment, the remote resource may use the sender 200's location as acquired in step S505 to find a nearby communications node 920 in the network 900, which could be a pre-installed hot spot, and is within the reach of short-range wireless communication signals, and the communications node 920 will generate wireless communications signals either broadcast to or specifically targeting the sender 200 to inform the sender 200 of the lookup request by the device 100, and optionally, also providing device 100's location and the contact information to the sender 200. Therefore, the sender 200 will be aware of the fact that someone is interested in its (his/her) profile via a third party, i.e., the remote resource 300. The communication signals can be the same type as communications signals 910 the sender sent to the device 200 to carry the transmission 600. The communication contents in step S517 can also conveyed to the sender 200 in the same way if the sender is not already a registered with the remote resource 300.

While the invention has been described in terms of several exemplary embodiments, those skilled in the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A communications device, comprising:
a processor;
a plurality of control modules to be executed and controlled by the processor, comprising:
a positioning module;
a communications module;
a interface (UI) module; and
a data module;
a receiver, controlled by the positioning module to receive location information of the device from one or more positioning systems, and controlled by the communications module to receive wireless communication transmissions;
a network unit controlled by communications module to establish network connections with a remote resource; and
a display,
wherein, when a transmission via wireless communications from a sender is received by the device, the data module retrieves a sender identifier (ID), location information from the received transmission; the UI module renders a map on the display by drawing symbols representing relative locations of the device and the sender based on the location information of the device and the retrieved location information of the sender; and
wherein the data module looks up a profile associated with the sender at the remote resource through the connections with the remote resource, and provides the device's ID, location information to the remote resource.

2. The communications device of claim 1, wherein the data module further retrieves contact information, description about the transmission from the received transmission, and the UI module further renders the contact information and the description on the map and associates the contact information and the description with the symbol for location of the sender.

3. The communications device of claim 2, further comprising a filtering module to be executed and controlled by the processor, wherein the filtering module checks the sender ID and the description to decide whether the received transmission is a request transmission or a response transmission, and the UI module draws the symbol of location of the sender differently for a request transmission from for a response transmission.

4. The communications device of claim 3, wherein the filtering module further determines whether the received transmission should be blocked by checking the sender ID, the retrieved description, a timestamp of the received transmission, or a distance between the sender and the device calculated based on the location information of the device and the sender, against a blocking list.

5. The communications device of claim 2, wherein when a plurality of transmissions from the sender are received in time sequence by the device, the data module retrieves the location information of the sender from each one of the plurality of transmissions and the UI module draws a symbol of location of the sender on the display for each said location information upon a condition that said location information represents a different location of the sender; and the UI module draws a symbol of location for the latest received one of the plurality of transmissions differently from the symbols for the previous ones of the plurality of transmissions.

6. The communications device of claim 1, further comprising a storage storing a database, wherein the data module looks up the profile associated with the sender in the database before looking up at the remote resource.

7. The communications device of claim 1, wherein the received transmission is sent via broadcast wireless signals.

8. The communications device of claim 1, wherein the receiver receives the location information of device from a satellite positioning system.

9. The communications device of claim 1, wherein the receiver receives the location information of the device both from a satellite positioning system and from an indoor positioning system; and where the strengths of both types of signals from the two positioning systems are above pre-determined threshold values, the signals from the indoor positioning system will be utilized to determine the location information.

10. A communications method, comprising:
providing a communications device comprising:
a processor;
a plurality of control modules to be executed and controlled by the processor, comprising:
a positioning module;
a communications module;
a interface (UI) module; and
a data module;
a receiver, controlled by the positioning module to receive location information of the device from one or more positioning systems, and controlled by the communications module to receive communication transmissions;
a network unit controlled by communications module to establish network connections with a remote resource; and
a display;
receiving by the receiver a broadcast communication transmission from a sender via wireless communications;
retrieving, by the data module, a sender identifier (ID), sender's location information from the received transmission;
receiving location information of the device received by the receiver from the one or more positioning systems;
rendering a map by the UI module on the display by drawing symbols showing relative locations of the device and the sender based on the received location information of the device and the retrieved location information of the sender; and
looking up a profile associated with the sender at the remote resource by connecting to the remote resource via the network unit.

11. The communications method of claim 10, further comprising:
retrieving contact information of the sender, description from the received transmission; and
further rendering the map by displaying the retrieved contact information and the description.

12. The communications method of claim 11, further comprising a step of filtering the received transmission, the step of filtering comprising:
determining whether the received transmission is a request transmission or a response transmission to a previous communication transmission from the device;
marking the received transmission differently as a request transmission from as a response transmission based on the determination;
determining whether the received transmission should blocked by checking the sender ID, the retrieved description, timestamp of the received transmission, or a distance between the sender and the device calculated based on the location information of the device and the sender, against a blocking list; and
blocking the received transmission after a blocking determination.

13. The communications method of claim 11, the step of profile lookup comprising:
providing the remote resource with the device's ID, location information, contact information; and
providing the remote resource with a profile ID to search for, the sender ID, the retrieved location information of the sender.

14. The communications method of claim 13, further comprising:
updating the map based on the profile returned from the profile lookup.

15. The communications method of claim 13, further comprising:
communicating with the sender by the remote resource using the sender ID and the location information of the sender;
informing, the remote resource, the sender of the profile lookup by the device; and
providing the sender with the device's ID and the location information of the device by the remote resource.

16. The communications method of claim 10, further comprising:
when a plurality of transmissions from the sender is received in time sequence, retrieving, by the data module, location information of each of the plurality of transmissions which represents a different location of the sender;
drawing, by the UI module, a symbol of location for each retrieved location information of the sender on the map; and
differentiating a symbol representing the latest location of the sender in the sequence from rest of the symbols for locations of the sender.

17. The communications method of claim 10, further comprising:
responding to the received transmission by sending a broadcasting, non real-time response transmission via wireless communications to the sender.

18. The communications method of claim 17, further comprising:
changing the symbol for the location of the sender on the map after responding to the received transmission.

19. A communications system, comprising:
a communications device, comprising:
a processor;
a plurality of control modules, executed and controlled by the processor, comprising:
a positioning module;
a communications module;
a interface (UI) module; and
a data module;
a receiver, controlled by the positioning module to receive location information of the device from a positioning system, and controlled by the communications module to receive wireless communication transmissions;
a network unit controlled by the communications module to establish network connections; and
a display; and
A remote resource connected to the device via the network unit,
wherein, when a communication transmission from a sender is received by the device, the data module retrieves a sender identifier (ID), location information from the received transmission; the UI module renders a map on the display to show relative locations of the device and the sender based on the location information of the device and the retrieved location information of the sender;
wherein the data module looks up a profile associated with the sender at the remote resource through the connections with the remote resource, and provides the remote resource with the device's ID, location information of the device, sender ID, and the location information of the sender; and
wherein the remote resource informs the sender of the profile lookup by the device and provides the sender with the device's ID and location information.

20. The communications system of claim 19, further comprising a communications node in a network connected with the remote resource, wherein the node is determined to be within a pre-determined distance from the sender based on the location information of the sender and suitable for wireless communications with the sender, and the remote resource sends information about the profile lookup to the node and the node wirelessly communicate the information to the sender.
